(19) United States
(12) Patent Application Publication
(10) Pub. No.: US 2026/0217259 A1
(43) Pub. Date: Jul. 30, 2026

(54) METHODS AND APPARATUS FOR ADAPTIVE TIRE SIZE LEARNING

(71) Applicant: Ford Global Technologies, LLC, Dearborn, MI (US)

(72) Inventors: John Eric Rollinger, Troy, MI (US); Scott Steadmon Thompson, Belleville, MI (US); Michael Scott Goebelbecker, Plymouth, MI (US); Daniel Francis Slavin, Oxford, MI (US)

(21) Appl. No.: 19/041,909

(22) Filed: Jan. 30, 2025

(51) Int. Cl. B60W 40/12; B60K 35/28

(52) U.S. Cl. CPC B60W 40/12; B60K 35/28; B60W 2530/18; B60W 2530/20

(57) ABSTRACT

Methods and apparatus for adaptive tire size learning are disclosed. A disclosed apparatus includes interface circuitry communicatively coupled to first and second sensors of a vehicle, machine-readable instructions, and at least one processor circuit to be programmed by the machine-readable instructions to calculate a distance traveled by a wheel of the vehicle based on coordinate of information of global navigation satellite system (GNSS) data corresponding to first output from the first sensor, determine a number of revolutions of a wheel of the vehicle based on second output from the second sensor, the number of revolutions corresponding to the distance traveled, and calculate a size parameter of a tire of the wheel based on the distance traveled and the number of revolutions.

### FIELD OF THE DISCLOSURE

This disclosure relates generally to vehicles and, more particularly, to methods and apparatus for adaptive tire size learning.

### BACKGROUND

Vehicle tires are in contact with a road surface and directly transfer forces that act on a vehicle. Tire sizes of the vehicle can vary based on pressure, heat, loading, speed etc. and, thus, can affect speed measurements, driving experience and fuel economy of the vehicle. Thus, it is desirable to ascertain the size of vehicle tires with respect to driving performance, fuel economy, instrumentation accuracy and comfort.

### SUMMARY

An example apparatus includes interface circuitry communicatively coupled to first and second sensors of a vehicle, machine-readable instructions, and at least one processor circuit to be programmed by the machine-readable instructions to calculate a distance traveled by a wheel of the vehicle based on coordinate information of global navigation satellite system (GNSS) data corresponding to first output from the first sensor, determine a number of revolutions of a wheel of the vehicle based on second output from the second sensor, the number of revolutions corresponding to the distance traveled, and calculate a size parameter of a tire of the wheel based on the distance traveled and the number of revolutions.

An example of at least one non-transitory machine-readable medium includes machine-readable instructions to cause at least one processor circuit to at least integrate a distance traveled by a wheel of a vehicle based on coordinate information of global navigation satellite system (GNSS) data, determine a number of revolutions of the wheel corresponding to the distance traveled, calculate a size parameter of a tire of the wheel based on the distance traveled and the number of revolutions, and cause a display of the vehicle to display the size parameter.

An example method includes calculating, by at least one processor, a distance traveled by a wheel of a vehicle based on coordinate information of global navigation satellite system (GNSS) data, determining, by the at least one processor, a number of revolutions of the wheel corresponding to the distance traveled, calculating by the at least one processor, a size of a tire of the wheel based on the distance traveled and the number of revolutions, and at least one of storing or displaying by the at least one processor, the size of the tire.

### BRIEF DESCRIPTION OF THE DRAWINGS

FIG. 1 illustrates a system in which examples disclosed herein can be implemented.

FIG. 2 illustrates an example process flow in accordance with teachings of this disclosure.

FIG. 3 is a schematic overview of a vehicle control system that can be implemented in examples disclosed herein.

FIGS. 4A and 4B illustrate example aspects of calculations that can be implemented in examples disclosed herein.

FIG. 5 is a block diagram of an example tire size parameter calculation system in accordance with teachings of this disclosure.

FIG. 6 is a flowchart representative of example machine readable instructions and/or example operations that may be executed, instantiated, and/or performed by example programmable circuitry to implement the tire size parameter calculation system of FIG. 5.

FIG. 7 is a block diagram of an example processing platform including programmable circuitry structured to execute, instantiate, and/or perform the example machine readable instructions and/or perform the example operations of FIG. 6 to implement the tire size parameter calculation system of FIG. 5.

FIG. 8 is a block diagram of an example implementation of the programmable circuitry of FIG. 7.

FIG. 9 is a block diagram of another example implementation of the programmable circuitry of FIG. 7.

FIG. 10 depicts example user interfaces/operations that can be implemented in examples disclosed herein.

FIG. 11 includes graphs depicting example results that may be achieved with examples disclosed herein.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Methods and apparatus for adaptive tire size learning are disclosed. With respect to vehicles, such as automobiles, tire size can affect speed measurement accuracy, driving experience, traction, etc. Accordingly, it can be advantageous to determine the tire size. Some known systems utilize a global navigation satellite system (GNSS), such as a global positioning system (GPS), to determine a ratio of a GPS-measured speed with a wheel speed. In turn, a tire size (e.g., a rolling radius) can be calculated for use in determination of a pressure, a tire condition, etc. However, the limitations of GPS accuracy as well as changes in operating range of the vehicle can adversely impact accuracy of the same.

Examples disclosed herein implement automatic tire size learning (ATSL) by utilizing GNSS data in combination with aggregate wheel revolution data to accurately calculate a tire size of a vehicle. The GNSS data can correspond to any type of positioning system and/or satellite system including, but not limited to, GPS, global navigation satellite system (GLONASS), European satellite navigation system (GALILEO), etc. In particular, examples disclosed herein utilize coordinate information (e.g., coordinates) of the GNSS data to determine and/or integrate a distance travelled by the vehicle and/or wheel of the vehicle in conjunction with a determined and/or calculated number of revolutions of the wheel to accurately determine/calculate the tire size (or other size parameter associated with a tire and/or wheel). As a result, examples disclosed herein can have increased accuracy over a longer range of travel of the vehicle. In particular, examples disclosed herein can utilize integration of distances (e.g., point-to-point integration over a distance, etc.), which improves in accuracy over increased distance traveled, thereby significantly increasing precision, which is highly advantageous over known single point techniques. Accordingly, by utilizing data over a significant range of travel/distance of the vehicle via integration, examples disclosed herein determine tire conditions in a counter-intuitive manner. Further, examples disclosed herein can also mitigate the limitations of common GNSS implementations, such as the relatively infrequent 1 Hertz (Hz) signal that is inherent with conventional GPS systems/hardware. Examples disclosed herein can include/exclude individual points for increased accuracy. Examples disclosed herein can normalize data over a wide operating range.

In some examples, an arc compensation is calculated for determination of a total distance traveled and/or coordinate data. Additionally or alternatively, a wheel position (e.g., a change in wheel position, a wheel center position, etc.) is calculated to determine the distance traveled by the wheel and/or the vehicle. In some examples, an entry condition of the vehicle is utilized as an input for calculation of the tire size of the vehicle. In some examples, a condition of the tire is calculated based on the determined size of the tire. According to some examples disclosed herein, a type and/or a designation (e.g., a size designation or class) of the tire is determined based on the calculated size of the tire. In some examples, pressure, tire wear, tire degradation and/or tire flat condition can be determined. In some such examples, a recommendation can be made to a user to change a tire. Additionally or alternatively, a user can be provided with information via display or other user interface to change a tire based on the condition of the tire. Some example implementations disclosed herein can adjust an estimated tire size based on pressure (e.g., tire pressure), degradation and/or temperature (e.g., tire temperature).

As used herein, the term “determine” encompasses calculations or other manners of obtaining numerical values having a finite degree of precision and, thus, are not necessarily exact and may, for example, be estimates.

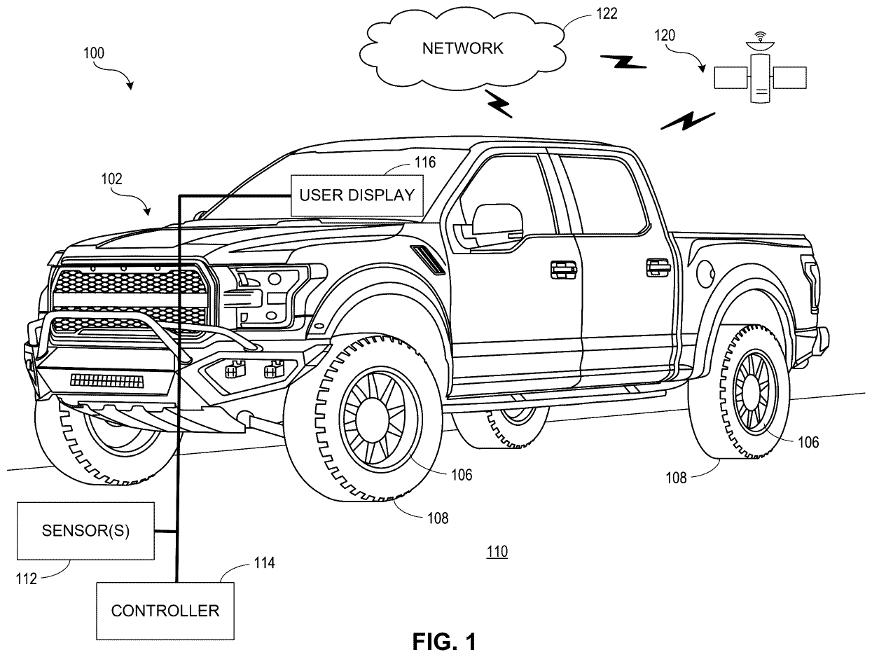

FIG. 1 represents an example system 100 in which the apparatus and methods disclosed herein may be implemented. The example system 100 includes an example vehicle 102 that utilizes sensor data/output to monitor vehicle systems (e.g., brake systems, tires, etc.). The example vehicle 102 may be a connected vehicle operative to share information via wireless communication (e.g., wireless internet, short-range communication channels, cellular signals).

The vehicle 102 of the illustrated example includes a plurality of wheels 106 to which tires 108 are coupled. In turn, the tires 108 are in contact with a road surface 110. The example vehicle 102 includes at least one sensor (e.g., an angular speed sensor, a rotational wheel sensor, a loading or force sensor, a pressure sensor, etc.) 112 that may be used to determine a condition of one or more of the vehicle 102, the tires 108 and/or the wheels 106. Further, the example vehicle 102 includes a controller 114 and a user interface/display 116.

According to examples disclosed herein, the vehicle 102 may be in communication with a system of satellites 120 (e.g., a global positioning system (GPS)) and/or a network 122. Specifically, the vehicle 102 and/or the controller 114 may be equipped with an integrated navigation system (communicatively coupled to or integral with the controller 114), whereby the integrated navigation system is communicatively coupled (e.g., receivably coupled) with one or more the GNSS/GPS satellites 120 and/or the network 122 to obtain information, including position and velocity of the vehicle 102. The information obtained via the integrated navigation system can subsequently be utilized by other systems and/or the controller 114 of the vehicle 102.

As will be discussed below in connection with FIGS. 1-12, examples disclosed herein determine and/or integrate a distance (e.g., a wheel distance, a distance traveled by the wheel, an aggregate distance, etc.) traveled based on coordinate information/data of GNSS data (e.g., GPS data) in conjunction with a number of wheel revolutions to calculate a tire size parameter (e.g., a tire circumference). Examples disclosed herein can accurately determine the tire size with accuracy that increases in relation to distance traveled, which is counterintuitive with respect to known systems. Examples disclosed herein utilize integration (e.g., point-to-point integration, point-to-point exclusion/inclusion, etc.) for distance calculations, which can advantageously increase accuracy and precision of data in comparison to known single point implementations.

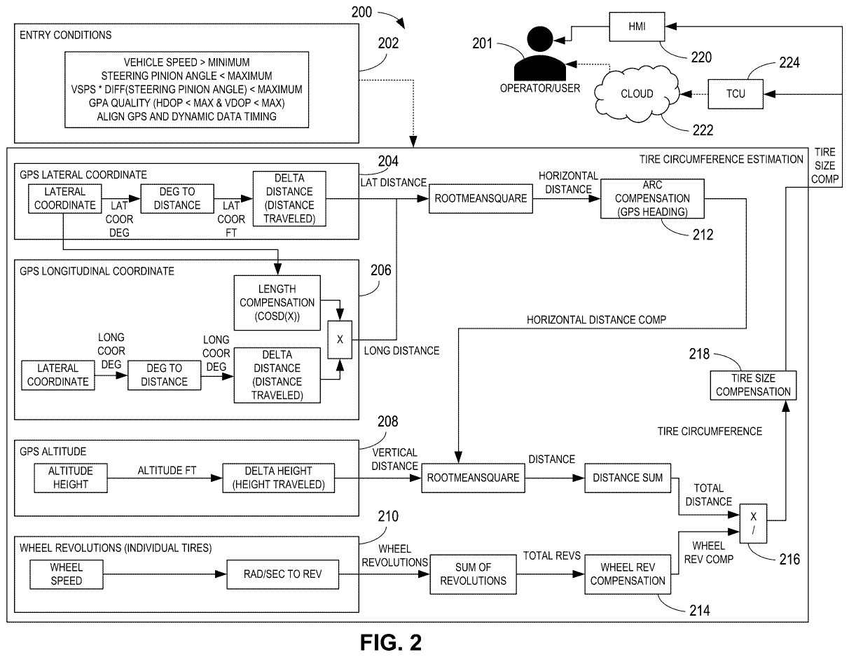

FIG. 2 illustrates an example process flow 200 in accordance with teachings of this disclosure. The example process flow 200 is to provide tire data to a user 201, which may be a driver and/or occupant of the vehicle 102. In the illustrated example of FIG. 2, at block 202, entry conditions are provided as an input. According to examples disclosed herein, the entry conditions can include, but are not limited to, vehicle speed, steering pinion angle, GPS data quality and timing data (GPS timing data), etc. Accordingly, GPS lateral coordinate information, GPS longitudinal coordinate information, GPS altitude information and wheel revolution data are determined and/or calculated at blocks 204, 206, 208, respectively. In this example, the GPS lateral coordinate information, the GPS longitudinal coordinate information, and the GPS altitude information are based on GPS data received at the vehicle 102 shown in FIG. 1.

To determine a distance sum and/or an integrated distance, distance differences (labelled as “delta distance” in FIG. 2) in both the lateral and longitudinal coordinates are utilized in conjunction with a height difference (labelled as “delta height” in FIG. 2). In this example, the lateral coordinates are utilized for a length compensation with respect to the longitudinal coordinate information to determine a longitudinal distance. In this example, a root mean square (RMS) calculation of the longitudinal and lateral/horizontal distances is utilized with the vertical distance corresponding to the GPS altitude information for determination of a distance sum (e.g., a wheel distance sum, a vehicle distance sum, etc.) that corresponds to an overall movement and/or displacement of the vehicle 102 and/or at least one wheel thereof.

According to some examples disclosed herein, at block 212, an arc compensation of the horizontal distance is performed (e.g., to account for turning of the vehicle 102, etc.) with respect to GPS data such that an arc length compensation can adjust for an added distance between GPS points while turning:

$$G P {S}_{C o u r s {e}_{diff}} = Zero Crossing correction ( delta ( {GPS}_{H e a d i n g} ) )$$

$${Arc}_{R a d i u s} = \frac{sin d ( \frac{180 - G P {S}_{C o u r s {e}_{diff}}}{2} )}{sin d ( {GPS}_{C o u r s {e}_{diff}} )} * {GPS}_{D i s t a n c e}$$

$$GP {S}_{Distance} = a distance between two consecutive points$$

$${Arc}_{Length} = {Arc}_{R a d i u s} * G P {S}_{C o u r s {e}_{Diff}} * \frac{π}{180}$$

In some examples, an arc distance is calculated between consecutive coordinates for an arc compensation.

In the illustrated example of FIG. 2, at block 210, to determine a total number of wheel revolutions (e.g., a sum of revolutions, an aggregate number of wheel revolutions, etc.) for each of the wheels 106 and/or the tires 108, a wheel speed is measured for each of the wheels 106 and/or the tires 108. For example, angular speed (e.g., in degrees/second) over time is integrated to determine an aggregate number of revolutions of the wheels 106 and/or the tires 108.

According to some examples disclosed herein, at block 214, a wheel revolution compensation of the horizontal distance is performed (e.g., to account for turning, different wheel rotations, different angular speeds of the wheels 106, etc.). Accordingly, an inner wheel to outer wheel compensation can be calculated as follows:

$${Radius}_{Curvature} = \vert \frac{\frac{vspd}{3600}}{{yaw}_{rate} * \frac{π}{180}} \vert$$

$${Adj}_{R a d i u s} = \sqrt{Radi {us}_{Curvature}^{2} - {( \frac{Wheelbase}{2} )}^{2}}$$

$$InnerRearWheelComp = \frac{{Adj}_{R a d i u s} - \frac{Track Width}{2}}{{Radius}_{Curvature}}$$

$$OuterRearWheelComp = \frac{{Adj}_{R a d i u s} + \frac{Track Width}{2}}{{Radius}_{Curvature}}$$

$$InnerFrontRadius = \sqrt{{( {Adj}_{R a d i u s} - \frac{Track Width}{2} )}^{2} + {Wheelbase}^{2}}$$

$$OuterFrontRadius = \sqrt{{( {Adj}_{R a d i u s} + \frac{Track Width}{2} )}^{2} + {Wheelbase}^{2}}$$

$$InnerFrontWheelComp = \frac{InnerFrontRadius}{{Radius}_{Curvature}}$$

$$OuterFrontWheelComp = \frac{OuterFrontRadius}{{Radius}_{Curvature}}$$

According to examples disclosed herein, at block 216, to calculate a size of at least one of the tires 108, the sum/aggregate distance traveled by at least one of the wheels 106 (e.g., an integrated wheel distance) and/or distance traveled by the vehicle in combination with the sum/aggregate number of wheel revolutions are utilized. In this example, the distance is divided by the number of wheel revolutions for calculation of tire circumferences of the tires 108.

At block 218, in some examples, a tire size compensation is performed. For example, a tire size compensation calculation can be performed with tire expansion/compression compensation, mapping tire temperature to tire expansion, mapping tire pressure to tire expansion, mapping wheel speed to tire expansion, mapping vehicle weight/axle weight to tire compression, etc. According to examples disclosed herein, the tire size compensation adjusts for differences in conditions (e.g., between different driving sessions, etc.).

In this example, the aforementioned user 201 is provided with tire data/information (e.g., tire size, inflation level, pressure level, etc.) corresponding to at least one of the tires 108 via a human machine interface (HMI) 220. In some examples, a network (e.g., a cloud-based network) 222 receives tire/wheel information from a transmission control unit (TCU) 224. In some such examples, the user 201 receives information from the network 222.

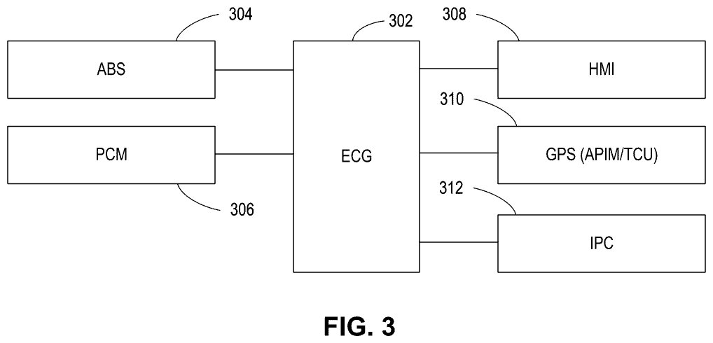

FIG. 3 is a schematic overview of a vehicle control system 300 that can be implemented in examples disclosed herein. In particular, the vehicle control system 300 can be implemented in, implemented with and/or communicatively coupled to the controller 114 shown in FIG. 1. In the illustrated example of FIG. 3, the vehicle control system 300 includes an enhanced central gateway (ECG) 302, an anti-lock braking system (ABS) 304, a power control module (PCM) 306, a human-machine interface (HMI) (e.g., an in-vehicle communication system) 308 that may be associated with an accessory protocol interface module (APIM), a GPS system 310 that corresponds to a TCU (e.g., the TCU 224) and/or the aforementioned APIM, and an instrument panel control (IPC) 312.

According to examples disclosed herein, in operation, wheel speed sensors of the ABS 304 are utilized to measure and/or ascertain angular speed, wheel rotation, etc. Further, the HMI 308 is utilized to provide information to and/or interact with a user (e.g., a driver, a vehicle operator, etc.). In this example, the GPS system 310 is implemented to determine a position and/or a speed of the vehicle 102 while the IPC 312 displays speed information to the user.

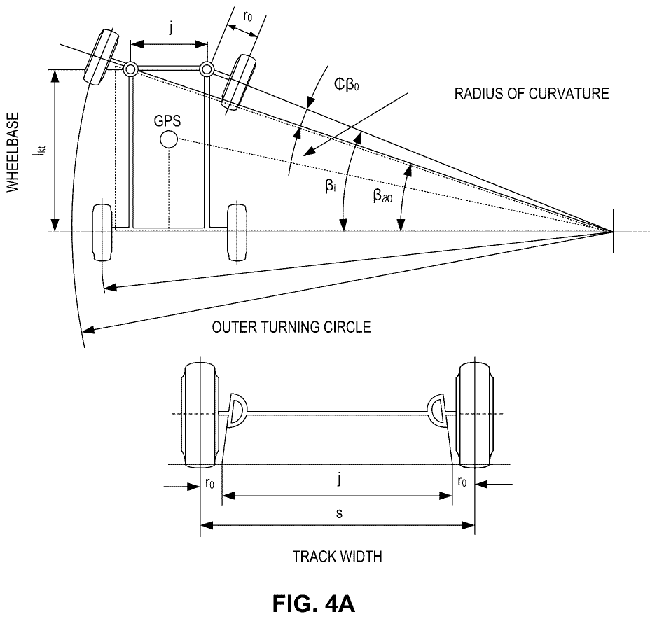

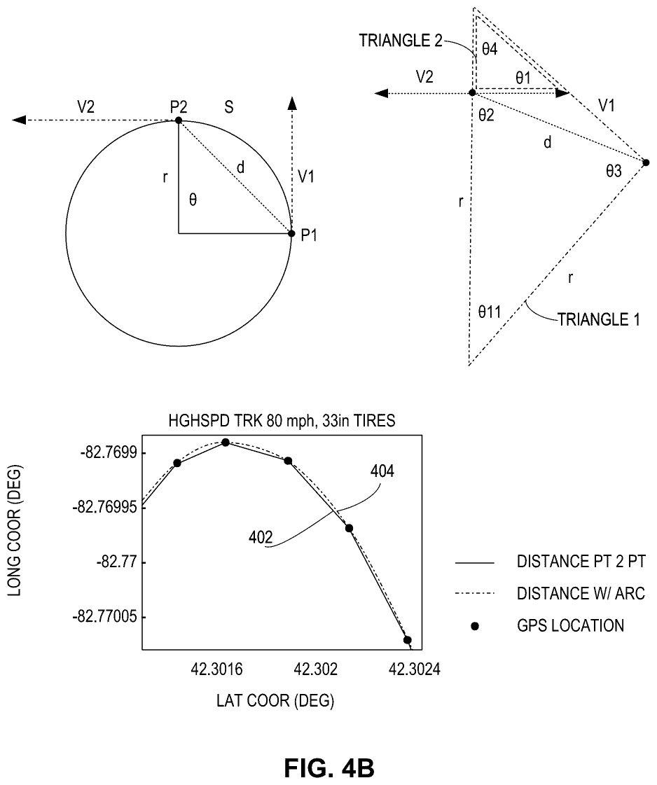

FIGS. 4A and 4B illustrate example aspects of calculations that can be implemented in examples disclosed herein. Turning to FIG. 4A, example aspects of characterizing wheel revolution compensation of a vehicle (e.g., the vehicle 102) are depicted. In the illustrated example of FIG. 4A, a GPS-based distance is used to estimate the circumference of each individual wheel while the GPS location data assumes and/or utilizes a position corresponding to the center of the vehicle and at each corner of the vehicle. This utilization of the center of the vehicle causes slight differences between the inner wheel versus the outer wheel, and the front wheel versus the rear wheel when turning, thereby causing the tire size estimate to slightly decrease or increase depending on the direction of the turn.

To adjust for the variation in wheel rotation caused by turning, examples disclosed herein can compensate for the location of the wheel to virtually move the location of the wheel to the vehicle center to match wheel revolutions to GPS distance. According to examples disclosed herein, differences between inner and outer rear wheels can be compensated for and/or determined by adjusting their position relative to the GPS/Center of Gravity position using the wheelbase and trackwidth of the vehicle. Accordingly, the following example calculations can be utilized:

$${Radius}_{Curvature} = \vert \frac{\frac{vspd}{3600}}{{yaw}_{rate} * \frac{π}{180}} \vert$$

$${Adj}_{R a d i u s} = \sqrt{Radi {us}_{Curvature}^{2} - {( \frac{Wheelbase}{2} )}^{2}}$$

$$InnerRearWheelComp = \frac{{Adj}_{R a d i u s} - \frac{Track Width}{2}}{{Radius}_{Curvature}}$$

$$OuterRearWheelComp = \frac{{Adj}_{R a d i u s} + \frac{Track Width}{2}}{{Radius}_{Curvature}}$$

According to examples disclosed herein, front wheels can be compensated for by finding their position relative to the rear wheels using the wheelbase of the vehicle. Example calculations can be expressed as:

$$InnerFrontRadius = \sqrt{{( {Adj}_{R a d i u s} - \frac{Track Width}{2} )}^{2} + {Wheelbase}^{2}}$$

$$OuterFrontRadius = \sqrt{{( {Adj}_{R a d i u s} + \frac{Track Width}{2} )}^{2} + {Wheelbase}^{2}}$$

$$InnerFrontWheelComp = \frac{InnerFrontRadius}{{Radius}_{Curvature}}$$

$$OuterFrontWheelComp = \frac{OuterFrontRadius}{{Radius}_{Curvature}}$$

FIG. 4B depicts example aspects of arc compensation that can be implemented in examples disclosed herein. In the illustrated example of FIG. 4B, arc compensation can be implemented to increase accuracy GPS of point-to-point (Pt2Pt) distance estimation (e.g., consecutive GPS/GNSS coordinate compensation) is smaller for a vehicle traveling at higher speeds while turning in relation to the actual arc distance traveled. Accordingly, examples disclosed herein can calculate the distance denoted as d corresponding to the vehicle traveled distance denoted as S.

Examples disclosed herein can estimate an arc of a turn with a GPS heading and a Pt2Pt Distance. Accordingly, a change/delta of GPS heading data can account for any zero crossing where the signal moves from 360 degrees to zero. In the example of FIG. 4B, GPS locations (e.g., GPS location points) are represented by P1 and P2 while GPS heading vectors are represented by V1 and V2. Further, a delta heading is represented by:

$$θ 1 = V 1 - V 2 ( Course Change ) ,$$

where d=distance between two consecutive GPS points

$$r = radius$$

$$S = Arc Length$$

As can be seen in FIG. 4B, congruent angles can be described as the following:

$$Triangle {1}_{90 °} : θ 1 + θ 4 = 90 - θ 4$$

$$Triangle {1}_{90 °} : θ 1 + θ 4 = 90 - θ 4$$

Accordingly, θ11=θ1 and arc length, S=rθ. Further, with respect to an r-r-d triangle,

$$θ 2 = θ 3 = \frac{180 - θ 1}{2}$$

$$\frac{sin d ( θ 3 )}{r} = \frac{sin d ( θ 11 )}{d} ( Law of Sines )$$

$$\frac{sin d ( \frac{180 - θ 1}{2} )}{r} = \frac{sin d ( θ 1 )}{d}$$

Further, an arc radius can be expressed as:

$$Arc radius = \frac{sin d ( \frac{180 - θ 1}{2} )}{sin d ( θ 1 )} * d with$$

$$Arc Length = {Arc}_{R a d i u s} * θ 1 .$$

According to examples disclosed herein, arc compensation can be utilized with respect to the vehicle 102 turning, as the vehicle 102 travels in an arc the distance is greater than the straight distance measured between two GPS coordinates with different headings. Without compensating for arc, the tire size can seem/appear smaller while turning. Accordingly, a corresponding compensation can be calculated using the GPS heading data and distance traveled. In some examples, delta GPS heading data can account for any zero crossing where the signal moves from 360 degrees to zero. The calculation is as follows:

$$GP {S}_{C o u r s {e}_{diff}} = Zero Crossing correction ( delta ( {GPS}_{H e a d i n g} ) ) .$$

Further, an arc radius can be determined and/or estimated with the arc radius determined/calculated using the Law of Sines:

$${Arc}_{R a d i u s} = \frac{sin d ( \frac{180 - G P {S}_{C o u r s {e}_{diff}}}{2} )}{sin d ( {GPS}_{C o u r s {e}_{diff}} )} * {GPS}_{D i s t a n c e}$$

As a result, an adjusted distance traveled can be calculated as an arc length between two consecutive GPS coordinates:

$${Arc}_{Length} = {Arc}_{R a d i u s} * G P {S}_{C o u r s {e}_{Diff}} * \frac{π}{180}$$

According to examples disclosed herein, integrated GPS coordinates are utilized for relatively precise tire size measurement. Accordingly, examples disclosed herein can combine GPS coordinate data such that GPS coordinates can be transmitted in multiple signals for increased resolution, such as degree, minutes, second or deca-minutes, etc., as expressed by the following example calculation:

$$Total Coordinates ( arc Second Degree ) = Degrees * 3600 + Minutes * 60 + Seconds$$

However, other coordinate protocol may utilize deca-minutes.

Further, coordinates can be converted to distance per the following. Lateral coordinates can essentially have the same arc second length because they are measured from the equator toward the poles (1 arcsec=101.27 feet). Longitude coordinates can have a decreasing arc-seconds length, which decreases in a trigonometric cosine as they approach the poles, for example. In particular, the 101.27 feet arc Second length at or near the equator can be adjusted by being multiplied by the cosine of the lateral coordinate as it moves toward the poles.

With respect to total/aggregate distance traveled, because degrees are measured from the equator in the lateral direction and the prime meridian in the longitudinal direction, the distances measured are also from these points. For the distance travel by the vehicle, a delta is calculated for each consecutive GPS data point in each direction can be expressed as:

$$Delta Lateral Distance = ( Lateral Coordinate 2 - Lateral Coordinate 1 ) * feet per - arc sec$$

$$Delta Lateral Distance = ( Lateral Coordinate 2 - Lateral Coordinate 1 ) * feet per - arc sec * cos ( Lateral Coordinate 2 )$$

$$Delta distance = \sqrt{Delta Lateral {Distance}^{2} + Delta Longitudinal {Distance}^{2}}$$

$$Delta GPS altitude = GPS altitude 2 - GPS altitude 1 ( GPS Altitude in units of length )$$

$$Delta Distance = \sqrt{\begin{matrix}Delta Lateral {Distance}^{2} + Delta Longitudinal {Distance}^{2} + \\ Delta GPS {altitude}^{2}\end{matrix}}$$

$$Total Distance Traveled = sum ( Delta Distance )$$

$$Tire Size = \frac{Total Distance Traveled}{Total Wheel Revolutions}$$

$$Total Wheel Revolutions = sum ( \frac{WheelSpeed}{2 * π} * dt )$$

or summing the total number of ABS wheel speed sensor pulses (Trigger wheel teeth) divided by the number of trigger wheel teeth per revolution

$$Tire Size = \frac{Total Distance Traveled}{Total Wheel Revolutions}$$

The calculations described above are only examples and appropriate other calculations and/or methodology can be implemented instead.

In the illustrated example of FIG. 4B, a graph is shown illustrating GPS data points. In this example, the data points have first and second lines 402, 404 therebetween. The first lines 402 correspond to point-to-point lines while second lines 404 correspond to arc compensation. In this example, the second lines 404 correspond to a more accurate positional relationship than the first lines 402.

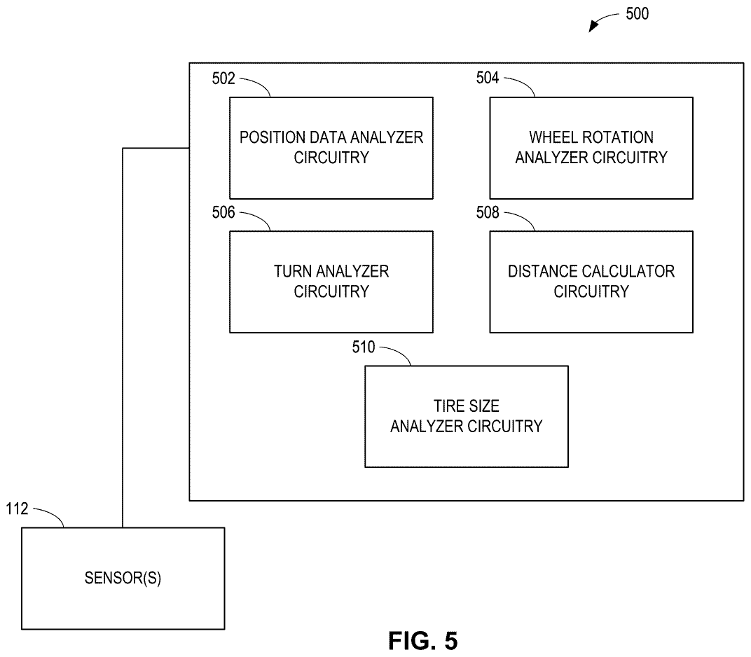

FIG. 5 is a block diagram of an example implementation of an example tire size parameter calculation system 500 to utilize GNSS data (e.g., GPS data, STARLINK® data, etc.) to characterize a size parameter of at least one tire of a vehicle (e.g., the vehicle 102). The tire size parameter calculation system 500 can be implemented in and/or utilized with the controller 114 shown in FIG. 1 and/or the vehicle control system 300 of FIG. 3. The example tire size parameter calculation system 500 of FIG. 5 may be instantiated (e.g., creating an instance of, bring into being for any length of time, materialize, implement, etc.) by programmable circuitry such as a Central Processor Unit (CPU) executing first instructions. Additionally or alternatively, the tire size parameter calculation system 500 of FIG. 5 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 5 may, thus, be instantiated at the same or different times. Some or all of the circuitry of FIG. 5 may be instantiated, for example, in one or more threads executing concurrently on hardware and/or in series on hardware. Moreover, in some examples, some or all of the circuitry of FIG. 5 may be implemented by microprocessor circuitry executing instructions and/or FPGA circuitry performing operations to implement one or more virtual machines and/or containers.

The example tire size parameter calculation system 500 includes example position data analyzer circuitry 502, example wheel rotation analyzer circuitry 504, example turn analyzer circuitry 506, example distance calculator circuitry 508 and example tire size analyzer circuitry 510. The example tire size parameter calculation system 500 can include and/or be communicatively coupled to the sensor(s) 112.

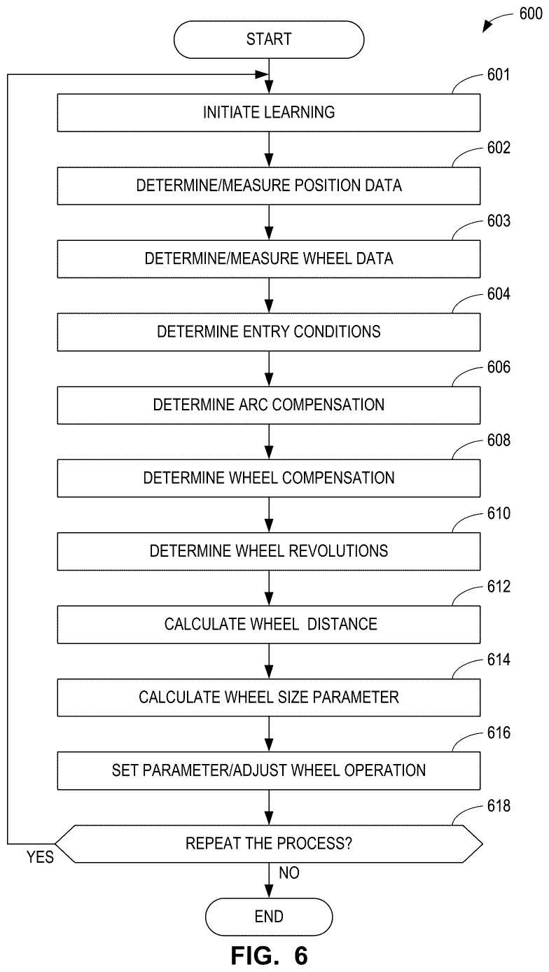

In the illustrated example of FIG. 5, the position data analyzer circuitry 502 is implemented to collect, analyze, and/or process positional/coordinate data of the vehicle based on sensor output corresponding to a GNSS sensor, such as a GPS sensor for example. According to some examples disclosed herein, the position data analyzer is utilized to generate GNSS data, such as coordinate data, of the vehicle (e.g., an array of coordinate positions of the vehicle). In some examples, the position data analyzer circuitry 502 is instantiated by programmable circuitry executing position data analyzer instructions and/or configured to perform operations such as those represented by the flowchart of FIG. 6.

The example wheel rotation analyzer circuitry 504 is implemented to calculate and/or determine a number of revolutions of at least one wheel of the vehicle. In this particular example, the wheel rotation analyzer circuitry 504 determines a number of revolutions of all of the wheels of the vehicle. Further, the example wheel rotation analyzer circuitry 504 can adjust and/or calculate the number of revolutions by determining a wheel revolution compensation. In some examples, the rotation analyzer circuitry 504 is instantiated by programmable circuitry executing rotation analyzer instructions and/or configured to perform operations such as those represented by the flowchart of FIG. 6.

According to examples disclosed herein, the turn analyzer circuitry 506 is implemented to accommodate for wheel speed variations with respect to turning. In particular, the turn analyzer circuitry 506 can account for turning performed by the vehicle. In some examples, the turn analyzer circuitry 506 is instantiated by programmable circuitry executing turn analyzer instructions and/or configured to perform operations such as those represented by the flowchart of FIG. 6.

In this example, the distance calculator circuitry 508 can utilize coordinate information of GNSS data from the position/data analyzer circuitry 502, for example. In turn, the distance calculator circuitry 508 can determine and/or integrate a distance traveled by a vehicle and/or at least one wheel of the vehicle based on the coordinate information of conventional GPS data. In some examples, the distance calculator circuitry 508 is instantiated by programmable circuitry executing distance calculator instructions and/or configured to perform operations such as those represented by the flowchart of FIG. 6.

The example tire size analyzer circuitry 510 is implemented to estimate, determine and/or calculate a size parameter associated with at least one tire of the vehicle. For example, the tire size analyzer circuitry 510 can determine a circumference of at least one tire and/or wheel assembly of the vehicle based on a number of revolutions of the tire in conjunction with the corresponding distance traveled by the vehicle. In some examples, the distance traveled by a tire of the vehicle is divided by the number of revolutions. The tire size analyzer circuitry 510 can be utilized to determine an inflation condition, a tire pressure, tire wear, etc. In some examples, the tire size analyzer circuitry 510 is instantiated by programmable circuitry executing tire size analyzer instructions and/or configured to perform operations such as those represented by the flowchart of FIG. 6.

While an example manner of implementing the tire size parameter calculation system 500 of FIG. 5 is illustrated in FIG. 5, one or more of the elements, processes, and/or devices illustrated in FIG. 5 may be combined, divided, re-arranged, omitted, eliminated, and/or implemented in any other way. Further, the example position data analyzer circuitry 502, the example wheel rotation analyzer circuitry 504, the example turn analyzer circuitry 506, the example distance calculator circuitry 508, the example tire size analyzer circuitry 510, and/or, more generally, the example tire size parameter calculation system 500 of FIG. 5, may be implemented by hardware alone or by hardware in combination with software and/or firmware. Thus, for example, any of the example position data analyzer circuitry 502, the example wheel rotation analyzer circuitry 504, the example turn analyzer circuitry 506, the example distance calculator circuitry 508, the example tire size analyzer circuitry 510, and/or, more generally, the example tire size parameter calculation system 500, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example tire size parameter calculation system 500 of FIG. 5 may include one or more elements, processes, and/or devices in addition to, or instead of, those illustrated in FIG. 5, and/or may include more than one of any or all of the illustrated elements, processes and devices.

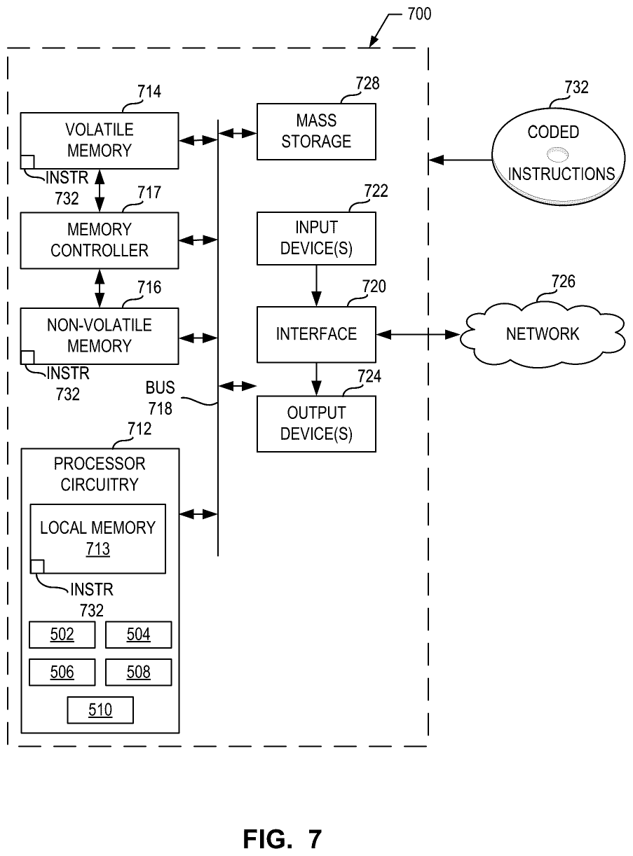

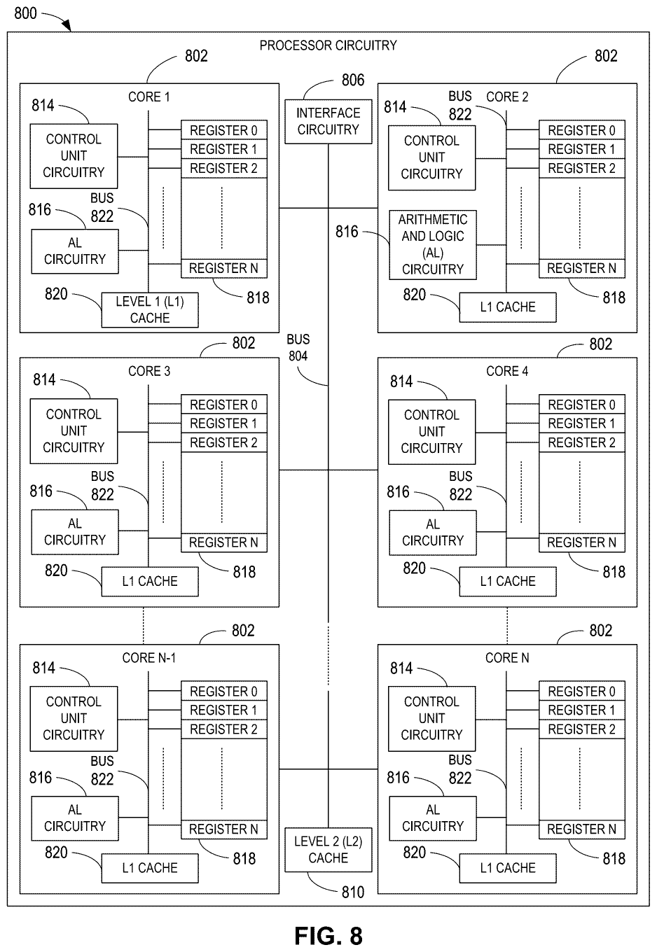

A flowchart representative of example machine readable instructions, which may be executed by programmable circuitry to implement and/or instantiate the tire size parameter calculation system 500 of FIG. 5 and/or representative of example operations which may be performed by programmable circuitry to implement and/or instantiate the tire size parameter calculation system 500 of FIG. 5, is shown in FIG. 6. The machine readable instructions may be one or more executable programs or portion(s) of one or more executable programs for execution by programmable circuitry such as the programmable circuitry 712 shown in the example processor platform 700 discussed below in connection with FIG. 7 and/or may be one or more function(s) or portion(s) of functions to be performed by the example programmable circuitry (e.g., an FPGA) discussed below in connection with FIGS. 8 and/or 9. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIG. 6, many other methods of implementing the example tire size parameter calculation system 500 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 6 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 6 is a flowchart representative of example machine readable instructions and/or example operations 600 that may be executed, instantiated, and/or performed by programmable circuitry to determine a size parameter of a tire and/or a wheel of a vehicle by utilizing GNSS data (e.g., GPS signal data). The example machine-readable instructions and/or the example operations 600 of FIG. 6 begin at block 601, at which a learning mode is initiated and/or activated. The learning mode may be initiated and/or activated based on detecting new tires (e.g., newly mounted tires) or whether a measured parameter of at least one tire has a exceeded a threshold degree of change.

At block 602, the position data analyzer circuitry 502 determines, accesses and/or retrieves position data. In this example, the position data corresponds to the GNSS data measured at the vehicle as the vehicle traverses an area and/or a distance/span.

At block 603, the example wheel rotation analyzer circuitry 504 determines, accesses and/or measures wheel data of the vehicle. In this example, the wheel rotation analyzer circuitry 504 receives and/or accesses angular wheel speed data over time as the vehicle traverses the area. Additionally or alternatively, the wheel rotation analyzer circuitry 504 receives aggregate rotational wheel data.

At block 604, in some examples, the position data analyzer circuitry 502 and/or the example wheel rotation analyzer circuitry 504 determines an entry condition data/information of the vehicle. The entry condition data/information can include, but is not limited to, vehicle speed, steering pinion angle, GPS data quality, data timing, etc.

At block 606, in some examples, the example turn analyzer circuitry 506 determines an arc/turning compensation corresponding to the wheel rotation data of the vehicle.

At block 608, in some examples, the example distance calculator circuitry 508 determines a wheel compensation corresponding to wheel positions of the vehicle. In particular, the wheel compensation may correspond to at least one difference between inner/outer wheels and/or front/rear wheels.

At block 610, the number of revolutions of at least one wheel of the vehicle is determined by the example wheel rotation analyzer circuitry 504. In this example, the wheel rotation analyzer circuitry 504 calculates the number of revolutions based on a measured angular/rotational velocity over time.

At block 612, the example distance calculator circuitry 508 determines and/or integrates a distance (e.g., an aggregate wheel distance, an integrated wheel distance, a vehicle travel distance, etc.) based on coordinate information of the GNSS data and the determined number of rotations thereof (e.g., with arc and wheel compensation performed). In this example, a number of rotations of a wheel is known with respect to the distance traveled by the wheel corresponding to the GNSS data, which may or may not be traveled in a same driving session of the vehicle. According to some examples disclosed herein the distance is determined and/or integrated by integration of segments between coordinates. In some examples, the coordinate information is adjusted (e.g., selected, included, excluded, etc.) for the distance calculation/integration. In some examples, a distance per rotation is calculated as a threshold number of valid GNSS coordinate points over a given distance travelled by the vehicle.

At block 614, the example tire size analyzer circuitry 510 determines at least one parameter (e.g., a size parameter, a wheel size parameter, a wheel/tire parameter, a rotation parameter, a wheel/tire circumference, a tire circumference, etc.) associated with the wheel and/or the tire of the vehicle. In this example, a circumference of a tire is determined by the example tire size analyzer circuitry 510. Additionally or alternatively, the example tire size analyzer circuitry 510 determines a condition of the tire and/or the vehicle based on the tire circumference. In some such examples, the example tire size analyzer circuitry 510 determines a pressure, a tire size classification (e.g., a manufacturer size, a nominal tire size, etc.), an inflation level, a flat tire, etc. based on the aforementioned circumference. In some examples, the at least one parameter and/or the distance traveled (e.g., the distance traveled by at least one wheel) is adjusted based on condition differences (e.g., pressure differences, temperature differences, etc.). For example, a wheel and/or tire circumference may be adjusted based on measured conditions of the vehicle corresponding to the GNSS data. In some examples, a confidence level of the parameter of the wheel is determined based on the distance travelled (e.g., a threshold GNSS distance has been reached).

At block 616, in some examples disclosed herein, the example tire size analyzer circuitry 510 sets a parameter (e.g., a wheel speed calibration) of the vehicle and/or causes an adjustment of an operation of the vehicle. This determination may be based on the circumference of the tire. Additionally or alternatively, the example tire size analyzer circuitry 510 adjusts a value and/or parameter of the vehicle (e.g., a tire size setting) for subsequent operation of the vehicle. In some examples, the example tire size analyzer circuitry 510 prompts a user/driver of the vehicle (e.g., to alert the driver to an underinflated tire, excessive tire wear, etc.).

At block 618, the example tire size analyzer circuitry 510 determines whether to repeat the process. If the process is to be repeated (block 618), control of the process returns to block 601. Otherwise, the process ends. The determination may be based on whether an estimate of a size parameter of a tire has been determined and/or the estimate has converged to a requisite degree of accuracy (e.g., no further data is necessary to be calculated).

FIG. 7 is a block diagram of an example programmable circuitry platform 700 structured to execute and/or instantiate the example machine-readable instructions and/or the example operations of FIG. 6 to implement the tire size parameter calculation system 500 of FIG. 5. The programmable circuitry platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 700 of the illustrated example includes programmable circuitry 712. The programmable circuitry 712 of the illustrated example is hardware. For example, the programmable circuitry 712 can be implemented by one or more integrated circuits, logic circuits, FPGAs, microprocessors, CPUs, GPUs, DSPs, and/or microcontrollers from any desired family or manufacturer. The programmable circuitry 712 may be implemented by one or more semiconductor based (e.g., silicon based) devices. In this example, the programmable circuitry 712 implements the example position data analyzer circuitry 502, the example wheel rotation analyzer circuitry 504, the example turn analyzer circuitry 506, the example distance calculator circuitry 508, and the example tire size analyzer circuitry 510.

The programmable circuitry 712 of the illustrated example includes a local memory 713 (e.g., a cache, registers, etc.). The programmable circuitry 712 of the illustrated example is in communication with main memory 714, 716, which includes a volatile memory 714 and a non-volatile memory 716, by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717. In some examples, the memory controller 717 may be implemented by one or more integrated circuits, logic circuits, microcontrollers from any desired family or manufacturer, or any other type of circuitry to manage the flow of data going to and from the main memory 714, 716.

The programmable circuitry platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user (e.g., a human user, a machine user, etc.) to enter data and/or commands into the programmable circuitry 712. The input device(s) 722 can be implemented by, for example, an audio sensor, a microphone, a camera (still or video), a keyboard, a button, a mouse, a touchscreen, a trackpad, a trackball, an isopoint device, and/or a voice recognition system.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 700 of the illustrated example also includes one or more mass storage discs or devices 728 to store firmware, software, and/or data. Examples of such mass storage discs or devices 728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 732, which may be implemented by the machine readable instructions of FIG. 6, may be stored in the mass storage device 728, in the volatile memory 714, in the non-volatile memory 716, and/or on at least one non-transitory computer readable storage medium such as a CD or DVD which may be removable.

FIG. 8 is a block diagram of an example implementation of the programmable circuitry 712 of FIG. 7. In this example, the programmable circuitry 712 of FIG. 7 is implemented by a microprocessor 800. For example, the microprocessor 800 may be a general-purpose microprocessor (e.g., general-purpose microprocessor circuitry). The microprocessor 800 executes some or all of the machine-readable instructions of the flowcharts of FIG. 6 to effectively instantiate the circuitry of FIG. 5 as logic circuits to perform operations corresponding to those machine readable instructions. In some such examples, the circuitry of FIG. 5 is instantiated by the hardware circuits of the microprocessor 800 in combination with the machine-readable instructions. For example, the microprocessor 800 may be implemented by multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine readable instructions and/or operations represented by the flowchart of FIG. 6.

The cores 802 may communicate by a first example bus 804. In some examples, the first bus 804 may be implemented by a communication bus to effectuate communication associated with one(s) of the cores 802. For example, the first bus 804 may be implemented by at least one of an Inter-Integrated Circuit (I2C) bus, a Serial Peripheral Interface (SPI) bus, a PCI bus, or a PCIe bus. Additionally or alternatively, the first bus 804 may be implemented by any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 2 (L2 cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry (sometimes referred to as an ALU) 816, a plurality of registers 818, the local memory 820, and a second example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer based operations. In other examples, the AL circuitry 816 also performs floating-point operations. In yet other examples, the AL circuitry 816 may include first AL circuitry that performs integer-based operations and second AL circuitry that performs floating-point operations. In some examples, the AL circuitry 816 may be referred to as an Arithmetic Logic Unit (ALU).

The registers 818 are semiconductor-based structures to store data and/or instructions such as results of one or more of the operations performed by the AL circuitry 816 of the corresponding core 802. For example, the registers 818 may include vector register(s), SIMD register(s), general-purpose register(s), flag register(s), segment register(s), machine-specific register(s), instruction pointer register(s), control register(s), debug register(s), memory management register(s), machine check register(s), etc. The registers 818 may be arranged in a bank as shown in FIG. 8. Alternatively, the registers 818 may be organized in any other arrangement, format, or structure, such as by being distributed throughout the core 802 to shorten access time. The second bus 822 may be implemented by at least one of an I2C bus, a SPI bus, a PCI bus, or a PCIe bus.

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages.

The microprocessor 800 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 800, in the same chip package as the microprocessor 800 and/or in one or more separate packages from the microprocessor 800.

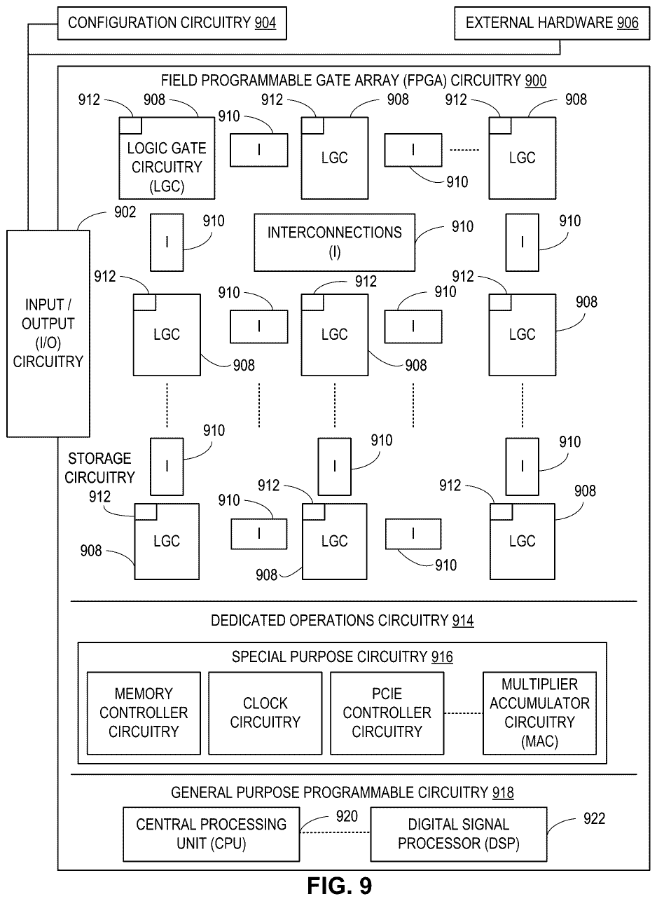

FIG. 9 is a block diagram of another example implementation of the programmable circuitry 712 of FIG. 7. In this example, the programmable circuitry 712 is implemented by FPGA circuitry 900. For example, the FPGA circuitry 900 may be implemented by an FPGA. The FPGA circuitry 900 can be used, for example, to perform operations that could otherwise be performed by the example microprocessor 800 of FIG. 8 executing corresponding machine readable instructions. However, once configured, the FPGA circuitry 900 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 800 of FIG. 8 described above (which is a general purpose device that may be programmed to execute some or all of the machine readable instructions represented by the flowchart of FIG. 6 but whose interconnections and logic circuitry are fixed once fabricated), the FPGA circuitry 900 of the example of FIG. 9 includes interconnections and logic circuitry that may be configured, structured, programmed, and/or interconnected in different ways after fabrication to instantiate, for example, some or all of the operations/functions corresponding to the machine readable instructions represented by the flowchart of FIG. 6. In particular, the FPGA circuitry 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the instructions (e.g., the software and/or firmware) represented by the flowchart of FIG. 6. As such, the FPGA circuitry 900 may be configured and/or structured to effectively instantiate some or all of the operations/functions corresponding to the machine readable instructions of the flowchart of FIG. 6 as dedicated logic circuits to perform the operations/functions corresponding to those software instructions in a dedicated manner analogous to an ASIC. Therefore, the FPGA circuitry 900 may perform the operations/functions corresponding to the some or all of the machine readable instructions of FIG. 6 faster than the general-purpose microprocessor can execute the same.

In the example of FIG. 9, the FPGA circuitry 900 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

The FPGA circuitry 900 of FIG. 9, includes example input/output (I/O) circuitry 902 to obtain and/or output data to/from example configuration circuitry 904 and/or external hardware 906. For example, the configuration circuitry 904 may be implemented by interface circuitry that may obtain a binary file, which may be implemented by a bit stream, data, and/or machine-readable instructions, to configure the FPGA circuitry 900, or portion(s) thereof. In some such examples, the configuration circuitry 904 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 906 may be implemented by external hardware circuitry. For example, the external hardware 906 may be implemented by the microprocessor 800 of FIG. 8.

The FPGA circuitry 900 also includes an array of example logic gate circuitry 908, a plurality of example configurable interconnections 910, and example storage circuitry 912. The logic gate circuitry 908 and the configurable interconnections 910 are configurable to instantiate one or more operations/functions that may correspond to at least some of the machine readable instructions of FIG. 6 and/or other desired operations. The logic gate circuitry 908 shown in FIG. 9 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations/functions. The logic gate circuitry 908 may include other electrical structures such as look-up tables (LUTs), registers (e.g., flip-flops or latches), multiplexers, etc.

The configurable interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example dedicated operations circuitry 914. In this example, the dedicated operations circuitry 914 includes special purpose circuitry 916 that may be invoked to implement commonly used functions to avoid the need to program those functions in the field. Examples of such special purpose circuitry 916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the programmable circuitry 712 of FIG. 7, many other approaches are contemplated. For example, FPGA circuitry may include an on-board CPU, such as one or more of the example CPU 800 of FIG. 8. Therefore, the programmable circuitry 712 of FIG. 7 may additionally be implemented by combining at least the example microprocessor 800 of FIG. 8 and the example FPGA circuitry 900 of FIG. 9. In some such hybrid examples, one or more cores 802 of FIG. 8 may execute a first portion of the machine readable instructions represented by the flowchart of FIG. 6 to perform first operation(s)/function(s), the FPGA circuitry 900 of FIG. 9 may be configured and/or structured to perform second operation(s)/function(s) corresponding to a second portion of the machine readable instructions represented by the flowchart of FIG. 6, and/or an ASIC may be configured and/or structured to perform third operation(s)/function(s) corresponding to a third portion of the machine readable instructions represented by the flowchart of FIG. 6.

It should be understood that some or all of the circuitry of FIG. 5 may, thus, be instantiated at the same or different times. For example, same and/or different portion(s) of the microprocessor 800 of FIG. 8 may be programmed to execute portion(s) of machine-readable instructions at the same and/or different times. In some examples, same and/or different portion(s) of the FPGA circuitry 900 of FIG. 9 may be configured and/or structured to perform operations/functions corresponding to portion(s) of machine-readable instructions at the same and/or different times.

In some examples, some or all of the circuitry of FIG. 5 may be instantiated, for example, in one or more threads executing concurrently and/or in series. For example, the microprocessor 800 of FIG. 8 may execute machine readable instructions in one or more threads executing concurrently and/or in series. In some examples, the FPGA circuitry 900 of FIG. 9 may be configured and/or structured to carry out operations/functions concurrently and/or in series. Moreover, in some examples, some or all of the circuitry of FIG. 5 may be implemented within one or more virtual machines and/or containers executing on the microprocessor 800 of FIG. 8.

In some examples, the programmable circuitry 712 of FIG. 7 may be in one or more packages. For example, the microprocessor 800 of FIG. 8 and/or the FPGA circuitry 900 of FIG. 9 may be in one or more packages. In some examples, an XPU may be implemented by the programmable circuitry 712 of FIG. 7, which may be in one or more packages. For example, the XPU may include a CPU (e.g., the microprocessor 800 of FIG. 8, the CPU 920 of FIG. 9, etc.) in one package, a DSP (e.g., the DSP 922 of FIG. 9) in another package, a GPU in yet another package, and an FPGA (e.g., the FPGA circuitry 900 of FIG. 9) in still yet another package.

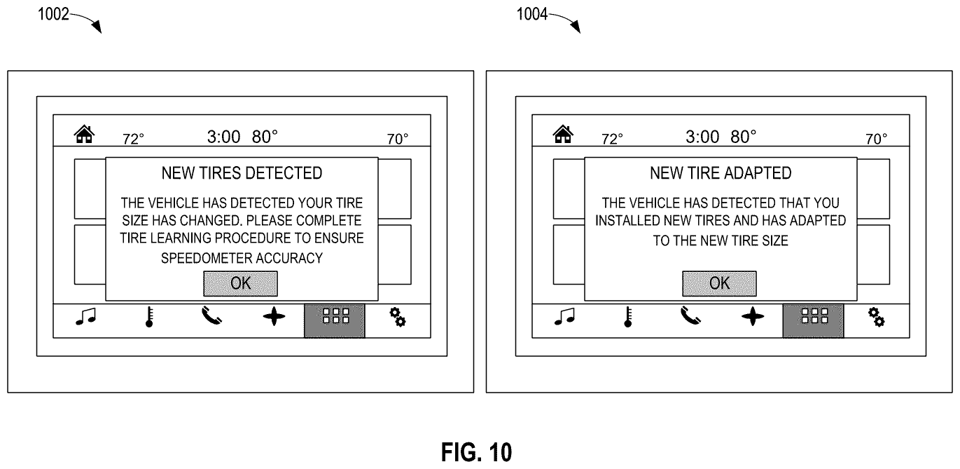

FIG. 10 depicts example user interfaces/operations that can be implemented in examples disclosed herein. In an example display 1002, a user interface (e.g., the user display 116 of FIG. 1), the vehicle (e.g., the vehicle 102) and/or a vehicle controller (e.g., the controller 114) determines that a new tire and/or a change in a tire parameter has been identified. In turn, a driver/user of the vehicle is prompted to perform and/or initiate a learning procedure to adjust the vehicle to a new tire or the change in the tire parameter. Accordingly, the driver/user can operate a user interface to initiate methodologies utilizing GNSS data in accordance with teachings of this disclosure.

In another example shown in display 1004, the vehicle automatically detects and adapts to a new and/or changed tire. In this example, the aforementioned vehicle controller determines that at least one tire of the vehicle has been changed (e.g., swapped) and/or the at least one tire has had a measured change that exceeds a threshold degree of change. In this example, the vehicle automatically adapts and/or learns the tire size by initiating determination of the tire size utilizing examples disclosed herein.

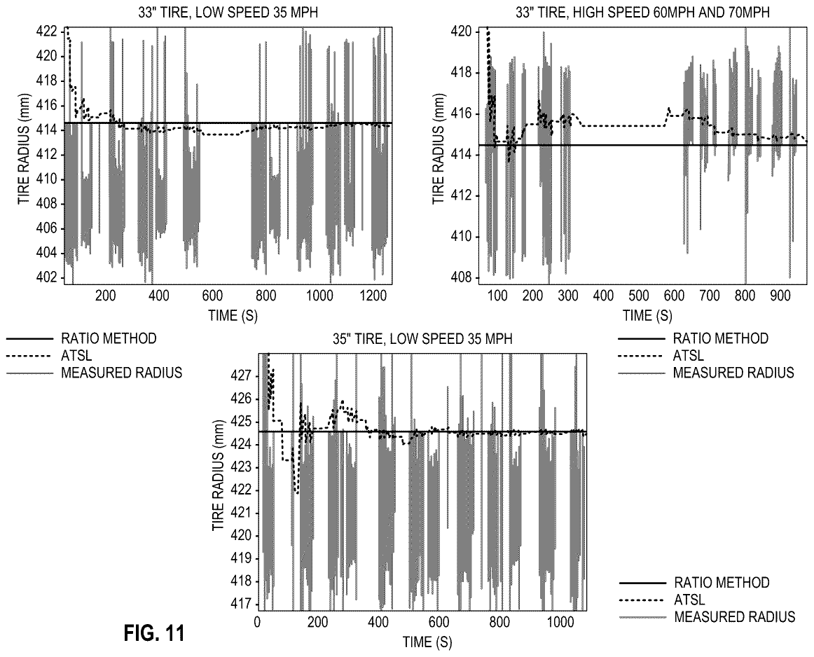

FIG. 11 includes graphs depicting example results that may be achieved with examples disclosed herein. In particular, the graphs shown in FIG. 11 distinguish ATSL performance in accordance with teachings of this disclosure along with tire circumference and a known ratio method in which a ratio of angular speed in combination with GPS speed is utilized to estimate a tire size. As can be seen in the illustrated view of FIG. 11, examples disclosed herein can accurately characterize a tire size in comparison to the known ratio method.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein, integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

Example methods, apparatus, systems, and articles of manufacture to enable accurate determination of tire size parameters (e.g., tire size, tire circumference, wheel/tire size, wheel/tire circumference, etc.) are disclosed herein. Further examples and combinations thereof include the following:

Example 1 includes an apparatus comprising interface circuitry communicatively coupled to first and second sensors of a vehicle, machine-readable instructions, and at least one processor circuit to be programmed by the machine-readable instructions to calculate a distance traveled by a wheel of the vehicle based on coordinate information of global navigation satellite system (GNSS) data corresponding to first output from the first sensor, determine a number of revolutions of a wheel of the vehicle based on second output from the second sensor, the number of revolutions corresponding to the distance traveled, and calculate a size parameter of a tire of the wheel based on the distance traveled and the number of revolutions.

Example 2 includes the apparatus as defined in example 1, wherein one or more of the at least one processor circuit is to cause a human-machine interface to display information corresponding to the size parameter of the tire.

Example 3 includes the apparatus as defined in example 1, wherein one or more of the at least one processor circuit is to calculate at least one arc compensation between consecutive coordinates of the coordinate information.

Example 4 includes the apparatus as defined in example 1, wherein one or more of the at least one processor circuit is to calculate at least one wheel position compensation relative to a vehicle center for calculation of the distance traveled.

Example 5 includes the apparatus as defined in example 1, wherein one or more of the at least one processor circuit is to integrate segments between GNSS coordinates to determine the distance traveled.

Example 6 includes the apparatus as defined in example 1, wherein one or more of the at least one processor circuit is to determine a condition of the tire based on the calculated size parameter of the tire.

Example 7 includes the apparatus as defined in example 1, wherein one or more of the at least one processor circuit is to determine a confidence level of the size parameter based on the distance calculated.

Example 8 includes the apparatus as defined in example 1, wherein one or more of the at least one processor circuit is to determine at least one condition of the vehicle corresponding to the GNSS data, and adjust at least one of the distance traveled or the size parameter based on the determined at least one condition.

Example 9 includes At least one non-transitory machine-readable medium comprising machine-readable instructions to cause at least one processor circuit to at least integrate a distance traveled by a wheel of a vehicle based on coordinate information of global navigation satellite system (GNSS) data, determine a number of revolutions of the wheel corresponding to the distance traveled, calculate a size parameter of a tire of the wheel based on the distance traveled and the number of revolutions, and cause a display of the vehicle to display the size parameter.

Example 10 includes the at least one non-transitory machine-readable medium of example 9, wherein the machine-readable instructions are to cause one or more of the at least one processor circuit to calculate at least one arc compensation between consecutive coordinates of the coordinate information.

Example 11 includes the at least one non-transitory machine-readable medium of example 9, wherein the machine-readable instructions are to cause one or more of the at least one processor circuit to adjust the coordinate information for the integration of the distance.

Example 12 includes the at least one non-transitory machine-readable medium of example 9, wherein the machine-readable instructions are to cause one or more of the at least one processor circuit to adjust the size parameter based on at least one vehicle condition associated with the GNSS data.

Example 13 includes the at least one non-transitory machine-readable medium of example 12, wherein the at least one vehicle condition includes at least one of a pressure or a temperature.

Example 14 includes the at least one non-transitory machine-readable medium of example 9, wherein the machine-readable instructions are to cause one or more of the at least one processor circuit to determine an inflation condition of the tire based on the calculated size parameter of the tire.

Example 15 includes the at least one non-transitory machine-readable medium of example 9, wherein the distance traveled is integrated by removing a portion of the coordinate information.

Example 16 includes a method comprising calculating, by at least one processor, a distance traveled by a wheel of a vehicle based on coordinate information of global navigation satellite system (GNSS) data, determining, by the at least one processor, a number of revolutions of the wheel corresponding to the distance traveled, calculating by the at least one processor, a size of a tire of the wheel based on the distance traveled and the number of revolutions, and at least one of storing or displaying by the at least one processor, the size of the tire.

Example 17 includes the method as defined in example 16, further including calculating, by the at least one processor, at least one wheel position compensation for calculation of the distance traveled.

Example 18 includes the method as defined in example 16, wherein calculating the distance traveled includes integrating segments between coordinates of the coordinate information.

Example 19 includes the method as defined in example 16, further including determining, by the at least one processor, an inflation condition of the tire based on the size of the tire.

Example 20 includes the method as defined in example 6, further including determining, by the at least one processor, that the tire has been changed or installed, and causing, by the at least one processor, collection of the GNSS data and revolution data of the tire in response to the determination that the tire has been changed or installed.

From the foregoing, it will be appreciated that example systems, apparatus, articles of manufacture, and methods have been disclosed that enable accurate determination of tire sizes of vehicles without necessitating extraneous specialized equipment. Examples disclosed herein can also enable effective onboard diagnostics for a vehicle. Disclosed systems, apparatus, articles of manufacture, and methods enhance the efficiency of using a computing device by reducing a need for filtering typically necessitated in known systems. Disclosed systems, apparatus, articles of manufacture, and methods are accordingly directed to one or more improvement(s) in the operation of a machine such as a computer or other electronic and/or mechanical device.

Such operations described herein should always be implemented and/or performed in accordance with the owner's manual and safety guidelines.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry communicatively coupled to first and second sensors of a vehicle;
machine-readable instructions; and
at least one processor circuit to be programmed by the machine-readable instructions to:
calculate a distance traveled by a wheel of the vehicle based on coordinate information of global navigation satellite system (GNSS) data corresponding to first output from the first sensor;
determine a number of revolutions of a wheel of the vehicle based on second output from the second sensor, the number of revolutions corresponding to the distance traveled; and
calculate a size parameter of a tire of the wheel based on the distance traveled and the number of revolutions.

2. The apparatus as defined in claim 1, wherein one or more of the at least one processor circuit is to cause a human-machine interface to display information corresponding to the size parameter of the tire.

3. The apparatus as defined in claim 1, wherein one or more of the at least one processor circuit is to calculate at least one arc compensation between consecutive coordinates of the coordinate information.

4. The apparatus as defined in claim 1, wherein one or more of the at least one processor circuit is to calculate at least one wheel position compensation relative to a vehicle center for calculation of the distance traveled.

5. The apparatus as defined in claim 1, wherein one or more of the at least one processor circuit is to integrate segments between GNSS coordinates to determine the distance traveled.

6. The apparatus as defined in claim 1, wherein one or more of the at least one processor circuit is to determine a condition of the tire based on the calculated size parameter of the tire.

7. The apparatus as defined in claim 1, wherein one or more of the at least one processor circuit is to determine a confidence level of the size parameter based on the distance calculated.

8. The apparatus as defined in claim 1, wherein one or more of the at least one processor circuit is to
determine at least one condition of the vehicle corresponding to the GNSS data; and
adjust at least one of the distance traveled or the size parameter based on the determined at least one condition.

9. At least one non-transitory machine-readable medium comprising machine-readable instructions to cause at least one processor circuit to at least:
integrate a distance traveled by a wheel of a vehicle based on coordinate information of global navigation satellite system (GNSS) data;
determine a number of revolutions of the wheel corresponding to the distance traveled;
calculate a size parameter of a tire of the wheel based on the distance traveled and the number of revolutions; and
cause a display of the vehicle to display the size parameter.

10. The at least one non-transitory machine-readable medium of claim 9, wherein the machine-readable instructions are to cause one or more of the at least one processor circuit to calculate at least one arc compensation between consecutive coordinates of the coordinate information.

11. The at least one non-transitory machine-readable medium of claim 9, wherein the machine-readable instructions are to cause one or more of the at least one processor circuit to adjust the coordinate information for the integration of the distance.

12. The at least one non-transitory machine-readable medium of claim 9, wherein the machine-readable instructions are to cause one or more of the at least one processor circuit to adjust the size parameter based on at least one vehicle condition associated with the GNSS data.

13. The at least one non-transitory machine-readable medium of claim 12, wherein the at least one vehicle condition includes at least one of a pressure or a temperature.

14. The at least one non-transitory machine-readable medium of claim 9, wherein the machine-readable instructions are to cause one or more of the at least one processor circuit to determine an inflation condition of the tire based on the calculated size parameter of the tire.

15. The at least one non-transitory machine-readable medium of claim 9, wherein the distance traveled is integrated by removing a portion of the coordinate information.

16. A method comprising:
calculating, by at least one processor, a distance traveled by a wheel of a vehicle based on coordinate information of global navigation satellite system (GNSS) data;
determining, by the at least one processor, a number of revolutions of the wheel corresponding to the distance traveled;
calculating by the at least one processor, a size of a tire of the wheel based on the distance traveled and the number of revolutions; and
at least one of storing or displaying, by the at least one processor, the size of the tire.

17. The method as defined in claim 16, further including calculating, by the at least one processor, at least one wheel position compensation for calculation of the distance traveled.

18. The method as defined in claim 16, wherein calculating the distance traveled includes integrating segments between coordinates of the coordinate information.

19. The method as defined in claim 16, further including determining, by the at least one processor, an inflation condition of the tire based on the size of the tire.

20. The method as defined in claim 6, further including:
determining, by the at least one processor, that the tire has been changed or installed; and
causing, by the at least one processor, collection of the GNSS data and revolution data of the tire in response to the determination that the tire has been changed or installed.
